(19) United States
(12) Patent Application Publication
(10) Pub. No.: US 2006/0059025 A1
(43) Pub. Date: Mar. 16, 2006

(54) Terminal device and session management device

(76) Inventors: Masao Kato, Kanagawa (JP); Masaki Takahashi, Tokyo (JP); Teruki Niki, Tokyo (JP)

Correspondence Address: GREENBLUM & BERNSTEIN, P.L.C., 1950 ROLAND CLARKE PLACE, RESTON, VA, 20191, US

(21) Appl. No.: 10/537,095

(22) PCT Filed: Dec. 22, 2003
(86) PCT No.: PCT/JP03/16431

§ 371 Date: Jun. 2, 2005

(30) Foreign Application Priority Data
Dec. 25, 2002 (JP) 2002-375305

(51) Int. Cl. G06Q 10/00; G06Q 99/00

(52) U.S. Cl. 705/5; 705/1

(57) ABSTRACT

A communication system capable of performing beneficial session hierarchical control. A server performs hierarchical control over sessions at a session control section based on a session control data. The session control data consists of session hierarchical control data and event operation control data. The former indicates a session ID and parent-child relationship between session IDs and the latter indicates information on a process operation (event process operation) carried out by the server when a session ID or the parent-child relationship between the session IDs is changed. The server executes process operations of closing a child session and transmitting a questionnaire when a call session is closed through a parent-child setting of a call session and catalog control session and reservation of questionnaire transmission to a call terminal of the other party.

### TECHNICAL FIELD

The present invention relates to a terminal apparatus and session control apparatus.

### BACKGROUND ART

With the widespread use and development of networks today, there is a design of a system like a tele-marketing service system which negotiates multimedia communication session conditions between communication terminals, then opens a multimedia communication session and performs video communication. In such a system, the use of a Session Initiation Protocol (SIP) to carry out real-time communication in a peer-to-peer connection between terminals or connection between terminals via a server is under study. The SIP is an application layer signaling protocol for establishing, changing or closing a multimedia session on an Internet Protocol (IP) network, and is currently being standardized by RFC3261.

For example, the Unexamined Japanese Patent Publication No. 2002-073516 discloses a technology that connects a new receiving terminal to a network to which a contents delivery terminal and a switching apparatus server are connected, receives a contents list request and contents transmission request to carry out contents distribution, further receives a bidirectional communication request and transmits contents from the receiving terminal to a contents distribution terminal to thereby enable bidirectional communication.

However, the conventional technology simply connects the receiving terminal to the network as a reception terminal, then additionally controls a transmission session to make it possible to connect many terminals and realize bidirectional functions on a case-by-case basis, and does not disclose any method of realizing a call session between terminals that provide various types of additional call services while maintaining a call in a bidirectional communication environment.

As tele-marketing services, various types of additional call service may be conceived such as advertisement delivery service, questionnaire service, interview/symposium service. In such various services, especially tele-marketing additional call services using a plurality of sessions, it would be very useful for a tele-marketing service provider that an opening or closing operation of a session be allowed according to the condition of another session, that is, hierarchical control of a session be allowed.

For example, when a salesman presents a customer questionnaire in a call sale with a customer using a call terminal, if it is possible to transmit the salesman's intention to send a questionnaire to the customer and display the questionnaire on the customer's call terminal immediately after the call sale is completed, and when presentation of product catalogs and documents, etc., can be closed simultaneously, it is possible to present documents not necessarily requiring the call to be continued, automatically collect the replies, proceed with a sale for the next customer, and moreover there is no need for complicated operation inputs to close many sessions, and therefore the realization of efficient sales as the system can be expected in all cases.

### DISCLOSURE OF INVENTION

It is an object of the present invention to provide a session control apparatus capable of carrying out beneficial session hierarchical control in a communication system.

According to an aspect of the present invention, a terminal apparatus (e.g., sales side) comprises a session opening request section that requests the opening of a session with a specified terminal apparatus, a reservation process setting request section that requests the setting of a reservation process executed when the opened session is changed and a session closing request section that requests the closing of an opened session.

According to another aspect of the present invention, a terminal apparatus (e.g., customer side) comprises a session opening request reception section that receives a session opening request requesting the opening of a session with the specified terminal apparatus, a session opening section that opens a session with a specified terminal apparatus according to the received session opening request, a session closing request reception section that receives a session closing request according to a reservation process executed when the opened session is changed according to the received session closing request and a session closing section that closes the opened session.

According to a further aspect of the present invention, a session control apparatus comprises a session opening request reception section that receives a session opening request requesting the opening of a session with a specified terminal apparatus, a reservation process setting request reception section that receives a reservation process setting request requesting the setting of a reservation process executed when the opened session is changed, a session closing request reception section that receives a first session closing request requesting the closing of the opened session, a hierarchy setting section that sets a hierarchal relationship among a plurality of opened sessions according to the received session opening request, a hierarchy update section that updates the set hierarchal relationship according to the received first session closing request, a reservation process setting section that sets a reservation process executed when the opened relationship is changed according to the received reservation process setting request, a reservation process execution section that executes the set reservation process according to the received first session closing request and a session closing request transmission section that transmits a second session closing request requesting the closing of a session with the specified terminal apparatus according to the closing of the reservation process executed.

### BRIEF DESCRIPTION OF DRAWINGS

FIG. 1 illustrates an example of the configuration of a communication system including a session control apparatus according to an embodiment of the present invention;

FIG. 2 illustrates connections among the apparatuses in FIG. 1;

FIG. 3 is a sequence diagram illustrating an example of a session control process according to this embodiment;

FIG. 4 is a sequence diagram illustrating another example of a session control process according to this embodiment;

FIG. 5A illustrates an example of the configuration of session hierarchical control data making up the session control data in FIG. 1 and illustrates an initial state before starting session control;

FIG. 5B illustrates a state after the start of the session control corresponding to FIG. 5A;

FIG. 6 illustrates an example of the configuration of event operation control data making up the session control data in FIG. 1;

FIG. 7 is a main flow chart showing an example of steps of a session control process in the server in FIG. 1;

FIG. 8 is a flow chart showing the contents of the session sub control process in step ST1300 in FIG. 7;

FIG. 9 is a flow chart showing the contents of the session sub control process in step ST2100 in FIG. 7;

FIG. 10A illustrates an example of a catalog module download request message;

FIG. 10B illustrates an example of a download session opening request message;

FIG. 10C illustrates an example of a catalog download start request message;

FIG. 10D illustrates an example of a catalog control session opening request message;

FIG. 10E illustrates an example of a catalog display operation message;

FIG. 10F illustrates an example of a session hierarchical operation request message;

FIG. 10G illustrates an example of a reservation process setting request message;

FIG. 11 illustrates an example of the configuration of a questionnaire module included in the module data in FIG. 1;

FIG. 12 is a flow chart illustrating an example of steps of a questionnaire module reproduction process in a customer's call terminal;

FIG. 13A is a sequence diagram illustrating part of the process sequence of the entire system according to this embodiment;

FIG. 13B is a sequence diagram that follows FIG. 13A showing part of the process sequence of the entire system according to this embodiment;

FIG. 13C is a sequence diagram that follows FIG. 13B showing part of the process sequence of the entire system according to this embodiment; and

FIG. 13D is a sequence diagram that follows FIG. 13C showing part of the process sequence of the entire system according to this embodiment.

### BEST MODE FOR CARRYING OUT THE INVENTION

With reference now to the attached drawings, an embodiment of the present invention will be explained in detail below.

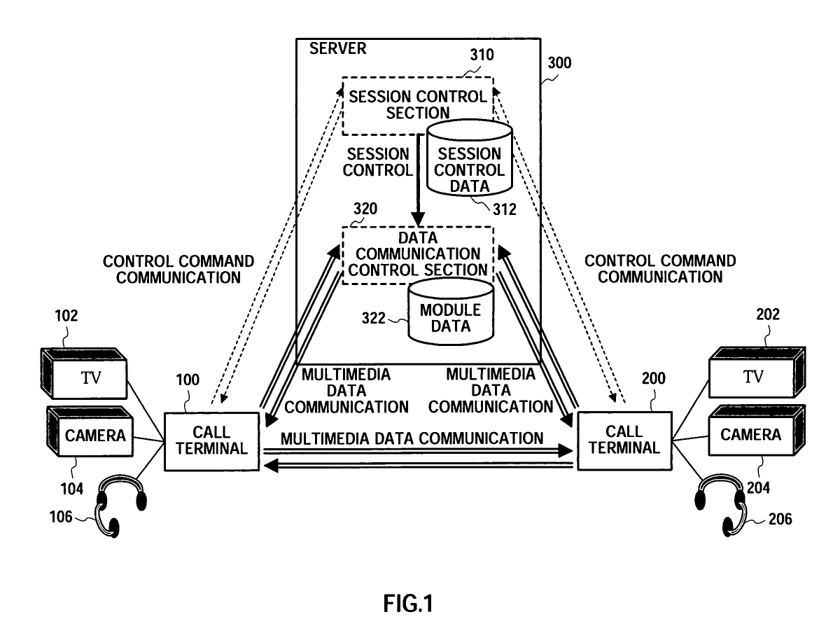

FIG. 1 illustrates an example of the configuration of a communication system including a session control apparatus according to an embodiment of the present invention. Here, a tele-marketing service system using an SIP will be explained as an example of a communication system.

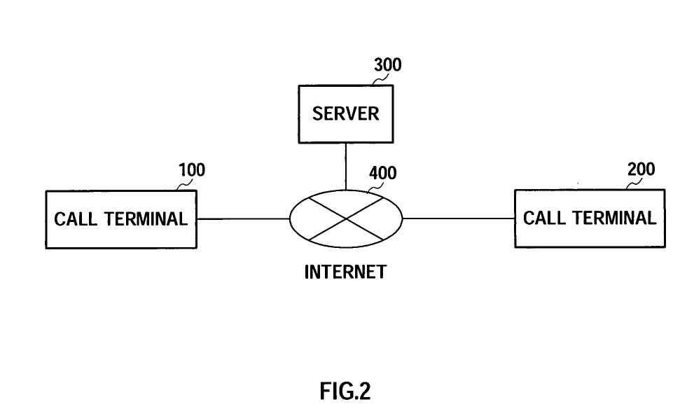

The system shown in FIG. 1 includes a salesman's call terminal 100, a customer's call terminal 200 and a tele-marketing service server (hereinafter simply referred to as “server”) 300. The call terminal 100, call terminal 200 and server 300 are mutually connected through the Internet 400 as shown in FIG. 2.

The respective call terminals 100, 200 are connected to TV monitors 102, 202, cameras 104, 204 and microphones 106, 206, input/output video from/to the user, receive user operation inputs of various types of control from an input apparatus (not shown) (e.g., operation keys of a remote controller and front panel, keyboard, touch panel, mouse, etc.) and perform additional call services with the other party, the call terminal 200 or 100 through the server 300 using multimedia data.

Here, the multimedia data is data including at least any one of video, speech, image and text. Furthermore, additional call services are, for example, advertisement delivery service, questionnaire service, interview/symposium service, etc.

The server 300 includes a session control section 310 as a session control apparatus and a data communication control section 320. The session control section 310 stores session control data 312 beforehand and the data communication control section 320 stores various types of module data 322 beforehand. Based on the session control data 312, the session control section 310 carries out control command communication with the respective call terminals 100, 200 to perform session control, or more specifically, control on session opening/closing processes. Based on various types of module data 322, the data communication control section 320 controls multimedia data communication through an opened session, or more specifically, controls a multimedia data addition service. Examples of the module data include data of an electronic catalog of specific products, catalog module including player functions and customer questionnaire module, etc. The session control data 312 will be explained in detail later.

Thus, in the system in FIG. 1, the respective call terminals 100, 200 have functions of transmitting or receiving various types of control commands to/from the server 300, opening a data communication session for multimedia data with the server 300 and controlling data communication at this opened session.

On the other hand, the server 300 has the functions of opening/closing a session with the respective call terminals 100, 200 and performing data communication control at the opened session, according to the various types of control commands received from the respective call terminals 100, 200.

As shown in FIG. 1, the call terminals 100, 200 can also carry out multimedia data communication with each other through a peer-to-peer connection bypassing the server 300 in services other than additional call services requiring processes by the server 300.

This embodiment will explain a case where a questionnaire module is realized as an application example of the download module. In that case, this embodiment also realizes a system for enabling registration of a “reservation process” executed when a session state is changed in addition to hierarchical control of sessions (that is, control by hierarchically organizing sessions) and realizes a system of controlling information through the server and notifying/registering various types of hierarchy information to/in the server when a session is opened/closed. For this purpose, this embodiment adds/sets a “session ID” (also simply abbreviated as “ID”) to/in the opened session to perform hierarchical control over sessions. The session ID is a logical identifier to identify an opened multimedia session.

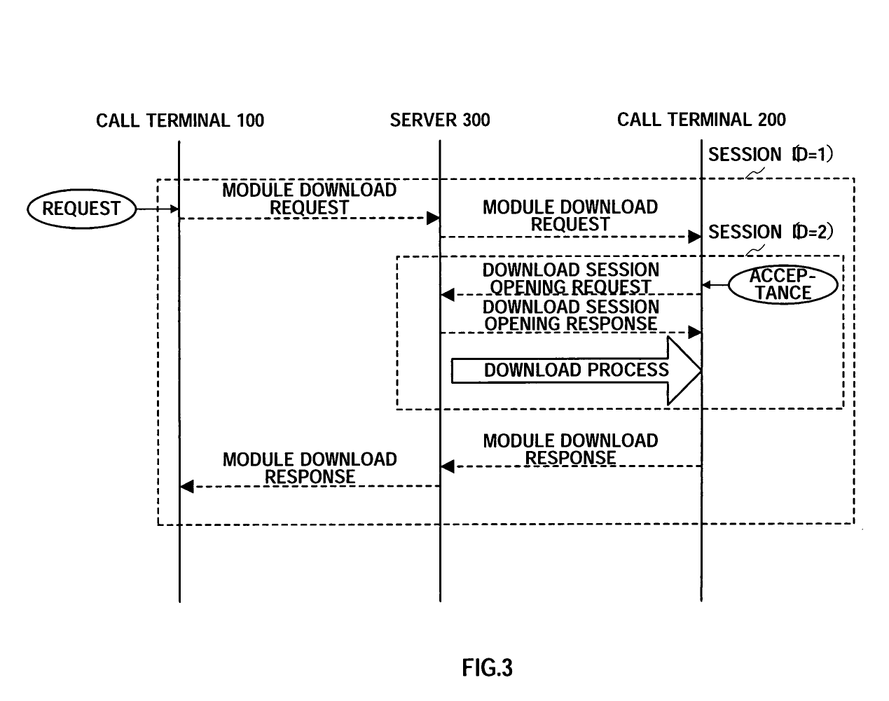

First, a method of controlling a session will be explained. Here, a procedure for transmitting/receiving a message between the call terminals 100, 200 and hierarchically controlling various sessions will be explained using FIG. 3 to FIG. 9. The session control data 312 is stored in the server 300 as described above.

(1) Concept of Session

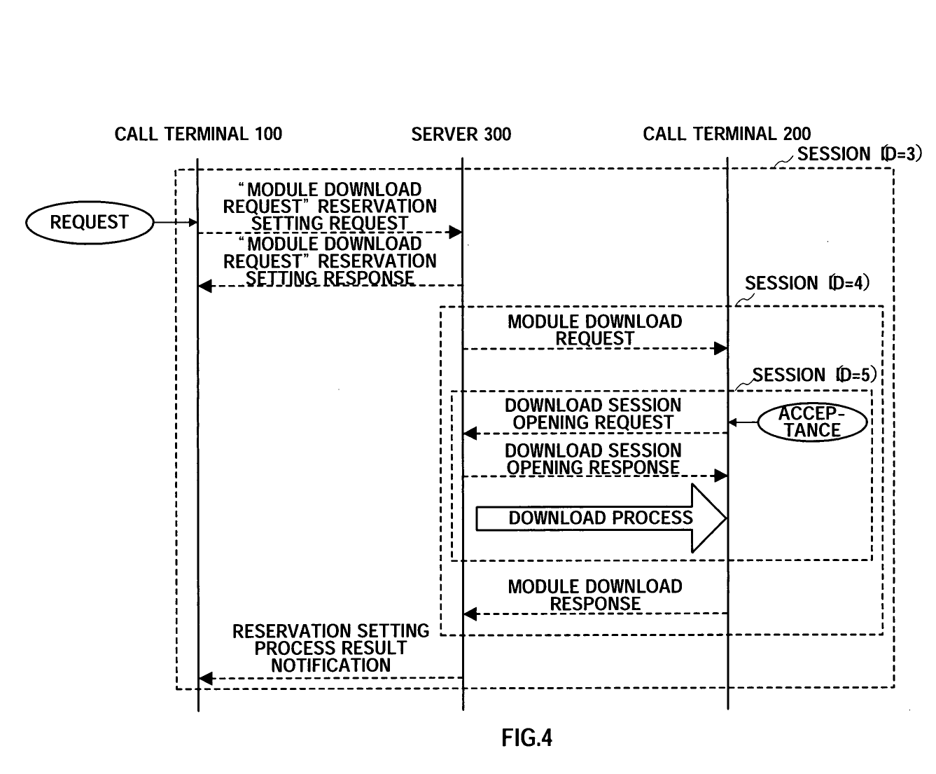

FIG. 3 and FIG. 4 are sequence diagrams showing examples of a session control process.

The respective call terminals 100, 200 transmit/receive a request message and a response message in response thereto, open a communication session and then execute one organized session process, such as, for example, transmitting/receiving call data or downloading a file module. Thus, a session ID is assigned to the corresponding message exchange process using such message process session as a unit to control sessions.

For example, FIG. 3 shows an example of a case where the call terminal 100 requests the call terminal 200 to download a module from the server 300 and perform a download process and shows that the following two process sessions are included.

Session 1 (ID=1): The call terminal 100 requests the call terminal 200 to “download a module from the server 300” and receives a response to the execution result from the call terminal 200.

Session 2 (ID=2): The call terminal 200 requests the server 300 to “open a module download communication session” and closes the session after the download process is completed.

Furthermore, FIG. 4 shows an example of a case where the call terminal 100 transmits a request to the server 300 to execute a module download process to the call terminal 200, causes the server 300 to per form the download process and shows that the following three process sessions are included:

Session 3 (ID=3): The call terminal 100 requests the server 300 to “communicate the call terminal 200 to ‘download a module from the server 300’” and receives a response of the execution result from the call terminal 200.

Session 4 (ID=4): The server 300 requests the call terminal 200 to “download a module from the server 300” and receives a response of the execution result from the call terminal 200.

Session 5 (ID=5): The call terminal 200 requests the server 300 to “open a module download communication session” and closes the session after completing the download process.

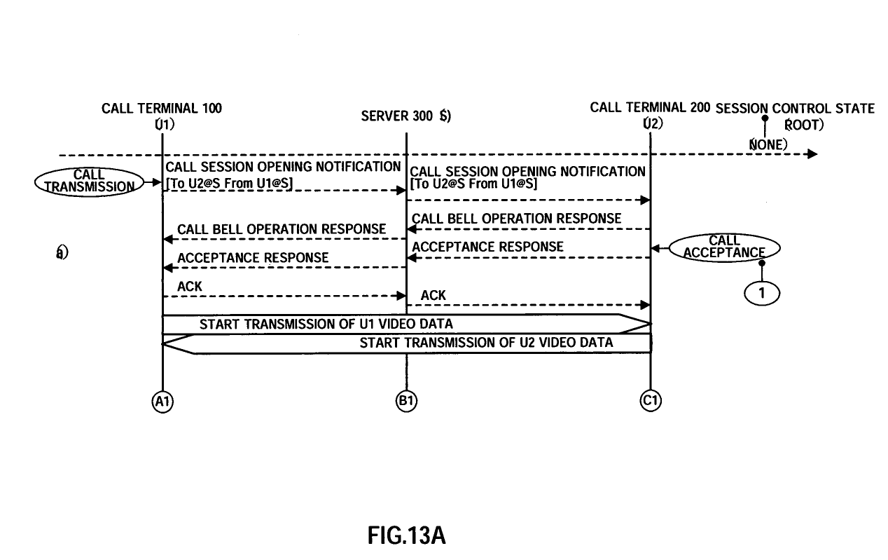

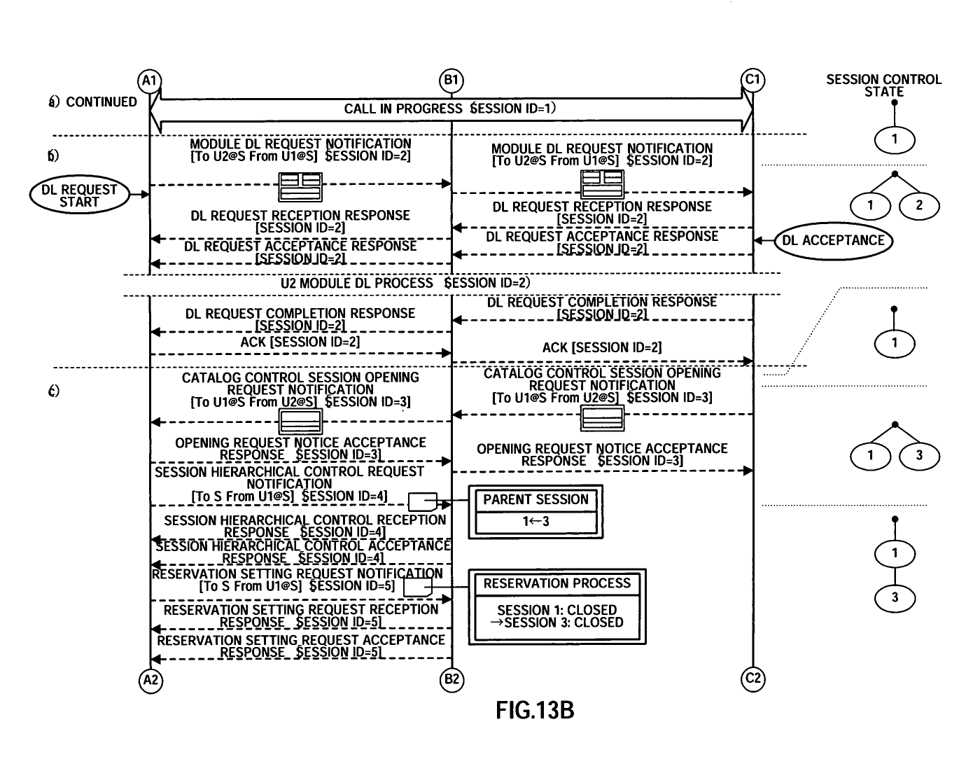

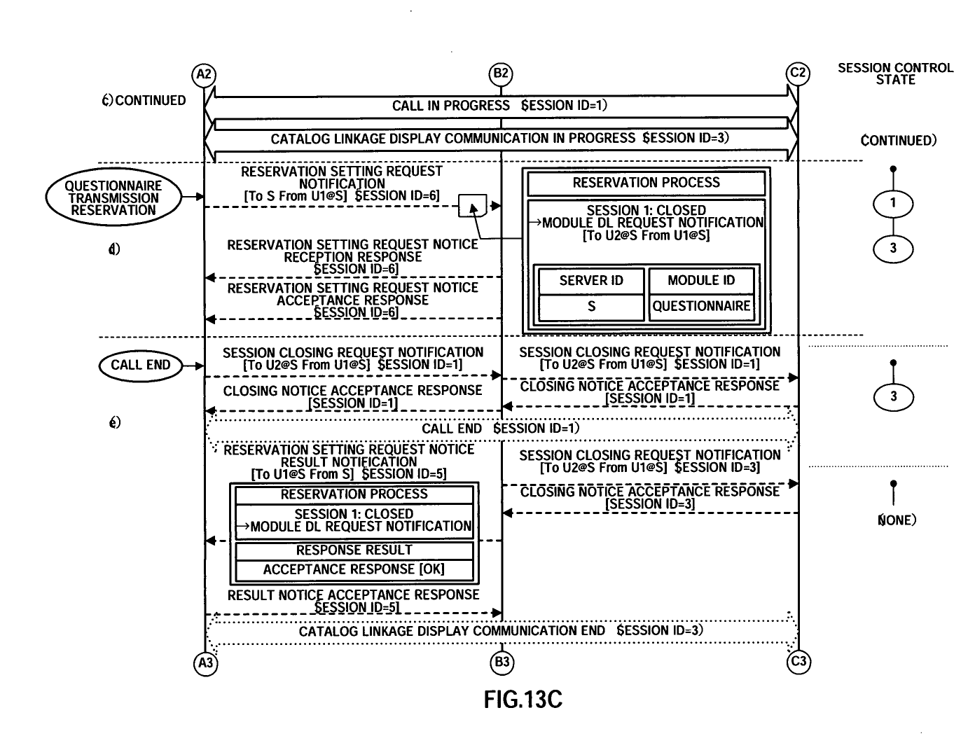

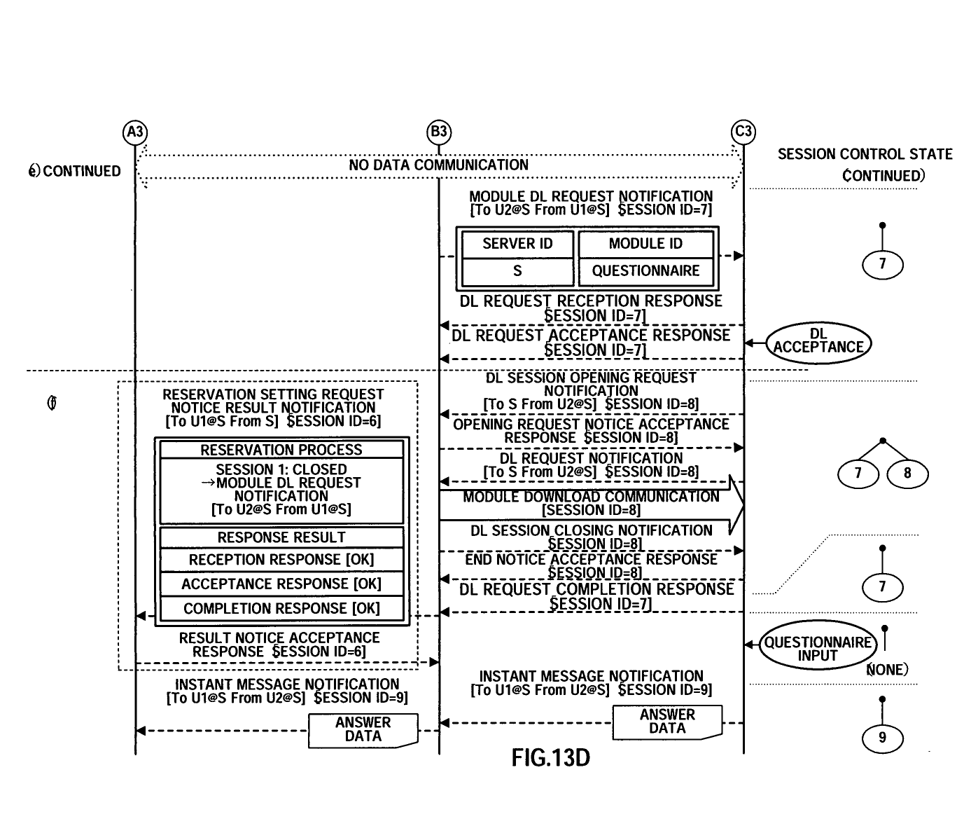

In the process sequence of the entire system (see FIG. 13A to FIG. 13D) which will be described later, preliminary messages to confirm transmission/reception of a request/response message are transmitted/received, but FIG. 3 and FIG. 4 show them as one session for simplicity.

(2) Issuance of Session ID and Hierarchical Control of Session

Use and control of a session ID is performed according to, for example, the following session ID utilization rules 1 to 5.

First, the session ID utilization rules 1 and 2 in order to generate and use a session ID to identify a session are, for example, as shown below.

Session ID utilization rule 1: The apparatus which issues a message to start a session generates a global and unique ID, adds the ID to a request message and sends the request message.

Session ID utilization rule 2: The apparatus which has received a request message with a new session ID added adds the same session ID to the message and responds.

Here, an ID can be anything if it is set at least based on a global and unique addition rule, and a specific example of the ID is a structure such as localID@host and “Randomness Recommendations for Security” specified in RFC1750, etc., can be used as a localID value.

Especially, the session ID utilization rules 3 to 5 processed by the server 300 to hierarchically control a session are as shown below:

Session ID utilization rule 3: The server 300 references messages received from the call terminals 100, 200 in addition to the session ID issued by the server 300 itself and stores and keeps the messages as long as the session issued by the call terminal 100, 200 exists.

Session ID utilization rule 4: The server 300 stores a session ID to be stored together with information on a parent-child relationship among session IDs and makes the hierarchical relationship information changeable by receiving a message of operating a hierarchical relationship from the call terminal 100, 200.

Session ID utilization rule 5: The server 300 stores information on the process operation (event process operation) carried out by the server 300 when a session ID or parent-child relationship among session IDs changes and sets the information using an operation setting message from the call terminal 100, 200.

Operation examples based on these rules 3 to 5 include a parent-child setting between a call session and catalog control session, closing of a child session at the closing of the call session and execution of a questionnaire transmission process operation through reservation of questionnaire transmission to the other party's call terminal (e.g., see stages (c) to (e) in FIG. 13B to FIG. 13D which will be described later). In addition to this, it is also possible to set an operation timing according to the control state at the server 300, for example, increase/decrease of child sessions, arrival at a maximum value and elapsed time after the start of a session.

(3) Session Control Process Method

Here, the operation of the server 300 that stores session control data and performs a session control process according to a received message will be explained.

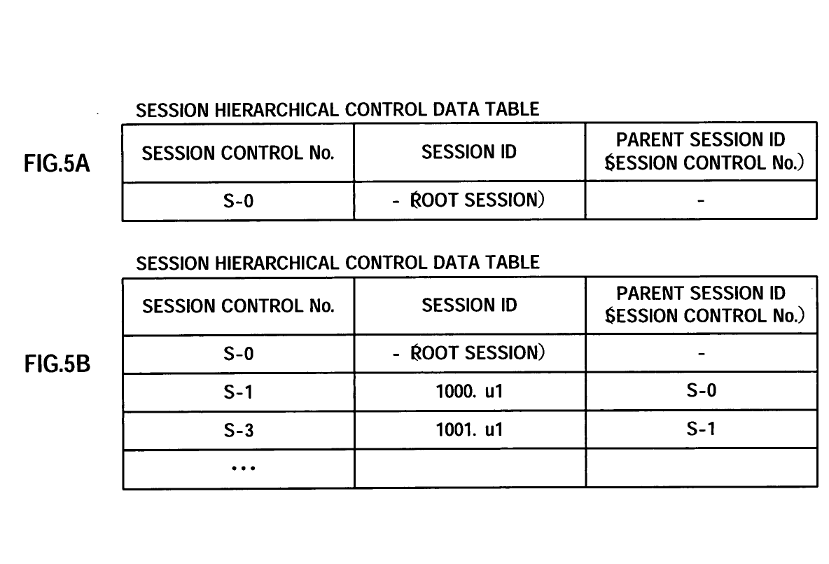

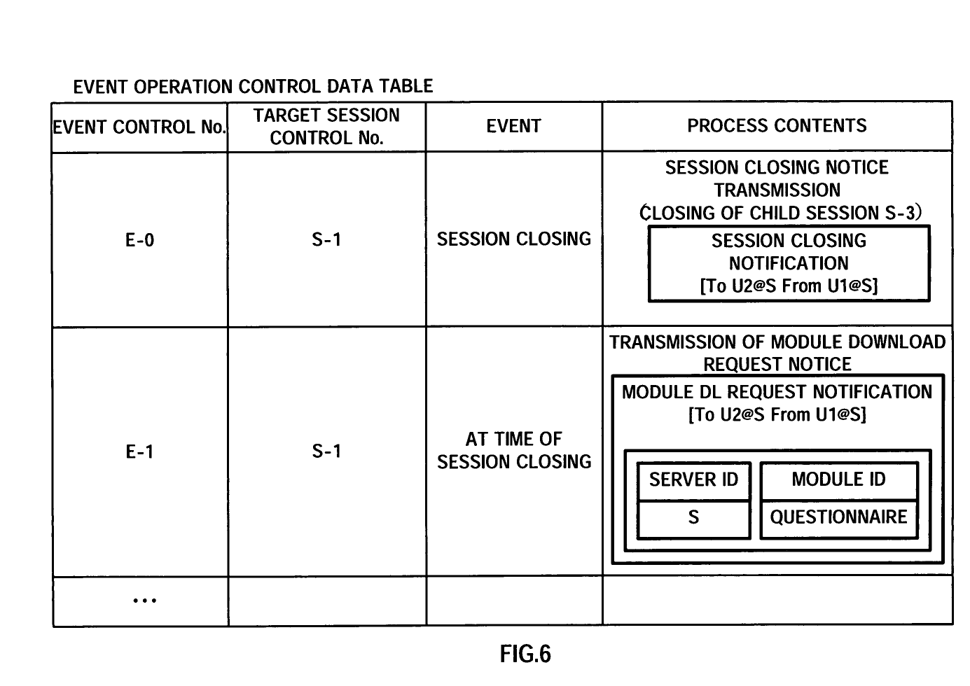

First, the session control data 312 will be explained. The session control data 312 consists of session hierarchical control data and event operation control data and is stored/controlled in a table format. FIG. 5A and FIG. 5B illustrate examples of the configuration of the session hierarchical control data. FIG. 6 illustrates an example of the configuration of the event operation control data. As shown in FIG. 5A and FIG. 5B, the session hierarchical control data is the data indicating a session ID and indicating, when the session is a child of another session, a session ID of the parent thereof. Here, FIG. 5A illustrates an initial state before session control is started and FIG. 5B illustrates a state after session control is started. Furthermore, as shown in FIG. 6, the event operation control data is the data indicating session IDs whose event process operation has been registered, event data which is the operation start condition thereof and action data which are the operation process contents.

In the same figure (or the same applies to other figures), “U1” denotes the call terminal 100, “U2” denotes the call terminal 200 and “S” denotes the server 300.

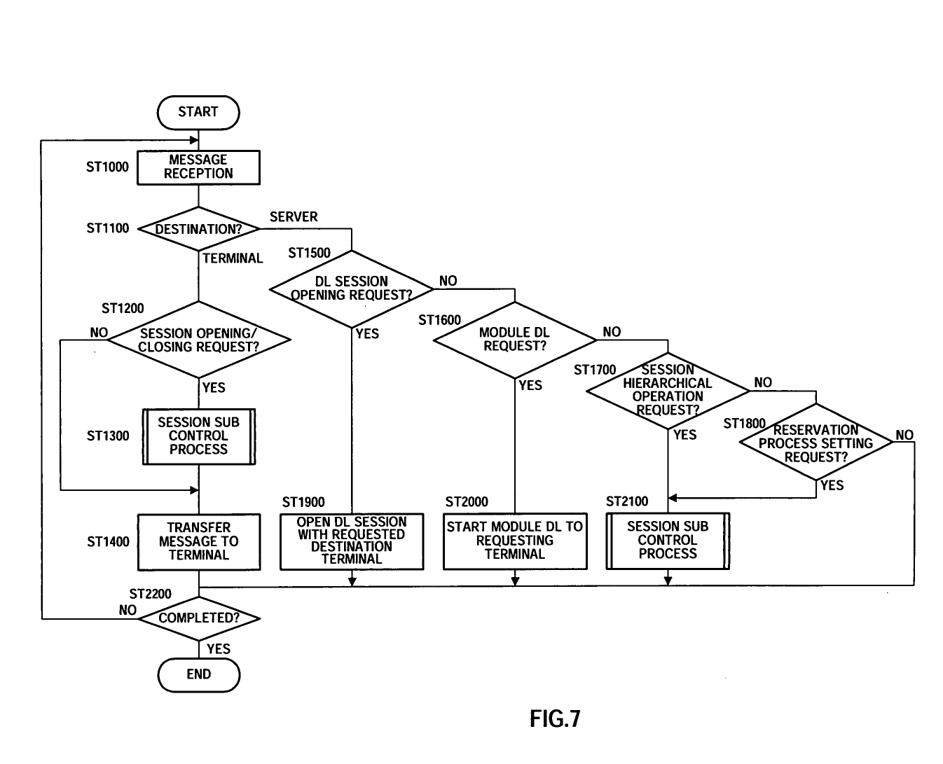

Next, the session control process at the server 300 will be explained using the flow charts in FIG. 7 to FIG. 9. Here, the session control process after a call session is opened will be explained for convenience. The process after the initial state shown in FIG. 5A until a call session is opened will be explained later (see stage (a) in FIG. 13A and FIG. 13B which will be explained later).

FIG. 7 is a main flow chart illustrating an example of steps of the session control process at the server 300.

First, in step ST1000, a message is received from the call terminal 100, 200.

Then, in step ST1100, the destination of the message received in step ST1000 is decided. When the decision result shows that the destination of the message is the call terminal, the process moves to step ST1200 and when the destination of the message is the server, the process moves to step ST1500.

In step ST1200, the contents of the message directed to the call terminal are decided, that is, it is decided whether the contents are a session opening or closing request message or other request message. When the decision result shows that the message directed to the call terminal is a session opening/closing request message (ST1200: YES), the process moves to step ST1300 and when the message directed to the call terminal is a request message other than the session opening/closing request message (ST1200: NO), the process immediately moves to step ST1400.

In step ST1300, a session sub control process is executed.

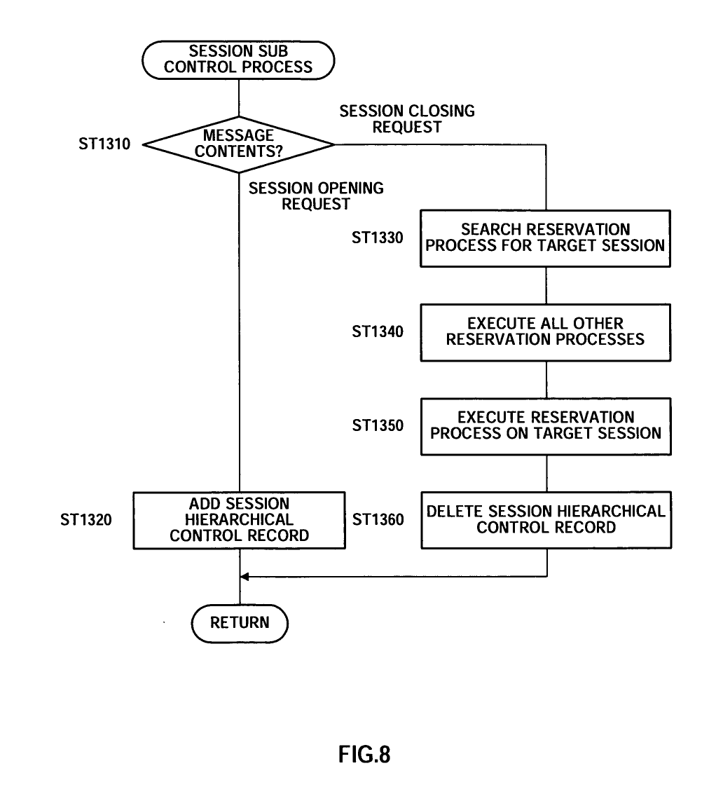

FIG. 8 is a flow chart showing the contents of the session sub control process in step ST1300 in FIG. 7.

In step ST1310, the contents of the message directed to the call terminal are decided, that is, it is decided whether the message is a session opening request message or a session closing request message. When the decision result shows that the message is a session opening request message, the process moves to step ST1320 and when the message is a session closing request message, the process moves to step ST1330.

In step ST1320, when the message is for a session opening request, a record (including a session hierarchical control record) is added to the session control data table, the session ID in the message is stored and then the process returns to the main flow chart in FIG. 7.

On the other hand, in step ST1330, when the message is for a session closing request, a reservation process on the target session is searched first.

Then, in step ST1340, all reservation processes generated along with the reservation process searched in step ST1330 are executed.

More specifically, after a list of reservation processes to be executed is received, one reservation process is extracted from the list, reservation processes generated along with this extracted reservation process are searched. When this search result shows that the corresponding reservation processes exist, all the reservation processes generated along with the reservation process are executed. On the contrary, when the search result shows that there is no corresponding reservation process, the reservation process to be executed is executed and the session hierarchical control record is deleted. Then, it is decided whether the next reservation process exists in the list or not and when this decision result shows that the next reservation process exists, the process returns to the process of extracting one reservation process from the list, repeats the same process as that described above or ends the subroutine when the next reservation process does not exist.

In step ST1350, a reservation process on the target session is executed.

Then, in step ST1360, after the session hierarchical control record is deleted, the process returns to the main flow chart in FIG. 7.

That is, in step ST1330 to step ST1360, when the message is for a session closing request, the record in the session control data table which stores the session ID in the message is deleted. However, if an event operation control data record which is set targeted at the closing of the session to be deleted exists, that operation control data record is processed.

Then, in step ST1400, after the message is transferred to the destination call terminal, the process moves to step ST2200. That is, in the case of a session opening/closing request message, after a session sub control process according to the message is executed, the message is transferred to the destination call terminal and in the case of a message other than the session opening/closing request message, the message is transferred to the destination call terminal as is.

On the contrary, when the message destination is the server, the contents of the message are decided in step ST1500 to step ST1800, that is, it is decided whether the message is a download (DL) session opening request message, module (e.g., catalog or questionnaire) download (DL) request message, session hierarchical operation request message or reservation process setting request message. Then, in the case of the first two, a server process (session opening, download) according to the message is executed. Furthermore, in the case of the last two, a session sub control process according to the message is executed.

That is, in step ST1500, the contents of the message directed to the server are decided, that is, it is decided whether the message is a download session opening request message or not. When this decision result shows that the contents of the message are of the download session opening request message (ST1500: YES), the process moves to step ST1900 or moves to step ST1600 otherwise (ST1500: NO).

In step ST1900, a download session with the call terminal of the requested download destination is opened and then the process moves to step ST2200.

On the other hand, in step ST1600, the contents of the message directed to the server are further decided, that is, it is decided whether the message is a module download request message or not. When this decision result shows that the contents of the message are of the module download request message (ST1600: YES), the process moves to step ST2000 or moves to step ST1700 otherwise (ST1600: NO).

In step ST2000, a module download to the call terminal which requested the download is started and the process moves to step ST2200.

On the other hand, in step ST1700, the contents of the message directed to the server are further decided, that is, it is decided whether the message is a session hierarchical operation request message or not. When this decision result shows that the contents of the message are of the session hierarchical operation request message (ST1700: YES), the process moves to step ST2100 or moves to step ST1800 otherwise (ST1700: NO).

In step ST1800, the contents of the message directed to the server are further decided, that is, it is decided whether the message is a reservation process setting request message or not. When this decision result shows that the message contents are of the reservation process setting request message (ST1800: YES), the process moves to step ST2100 or immediately moves to step ST2200 otherwise (ST1800: NO).

In step ST2100, a session sub control process is executed.

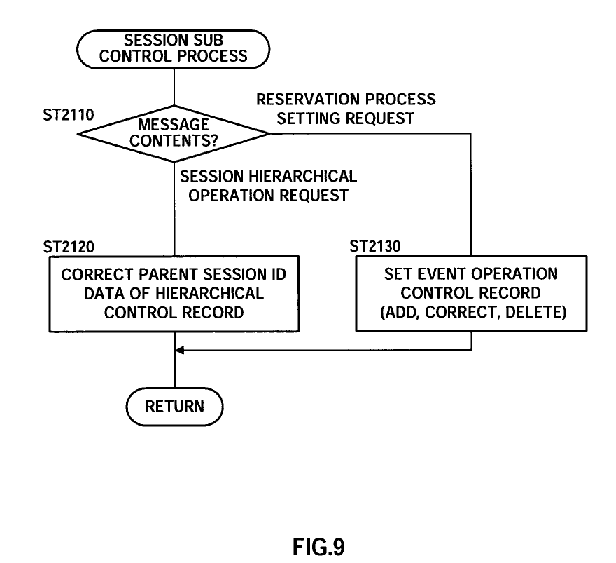

FIG. 9 is a flow chart showing the contents of the session sub control process in step ST2100 in FIG. 7.

In step ST2110, the contents of the message directed to the server are decided, that is, it is decided whether the message is a session hierarchical operation request message or reservation process setting request message. When this decision result shows that the message is the session hierarchical operation request message, the process moves to step ST2120 and when the message is the reservation process setting request message, the process moves to step ST2130.

In step ST2120, in the case of a session hierarchical operation request, the parent session ID of the record of the session hierarchical control data table (see FIG. 5B in particular) is operated and set (corrected) based on the corresponding message and then the process returns to the main flow chart in FIG. 7.

On the other hand, in step ST2130, in the case of a reservation process setting request, the record of the event operation control data table (see FIG. 6) is added/deleted or the value is set (corrected), and then the process returns to the main flow chart in FIG. 7.

Then, in step ST2200, it is decided whether the session control process is finished or not and when the session control process is not finished (ST2200: NO), the process returns to step ST1000 and repeats a series of processes in step ST1000 to step ST2100 until the session control process is finished.

The session sub control process in step ST1300 has illustrated the execution of the reservation process (see FIG. 8) based on only the session closing event, but the session sub control process is not limited to this and it is also possible to execute the session sub control process by adding a similar procedure of registering other event processes in the session control data and searching and executing the event processes.

Furthermore, it goes without saying that the order in which the contents of the message directed to the server are decided is not limited to the order shown in step ST1500 to step ST1800. That is, the download session opening request message, module download request message, session hierarchical operation request message and reservation process setting request message can be decided in any order.

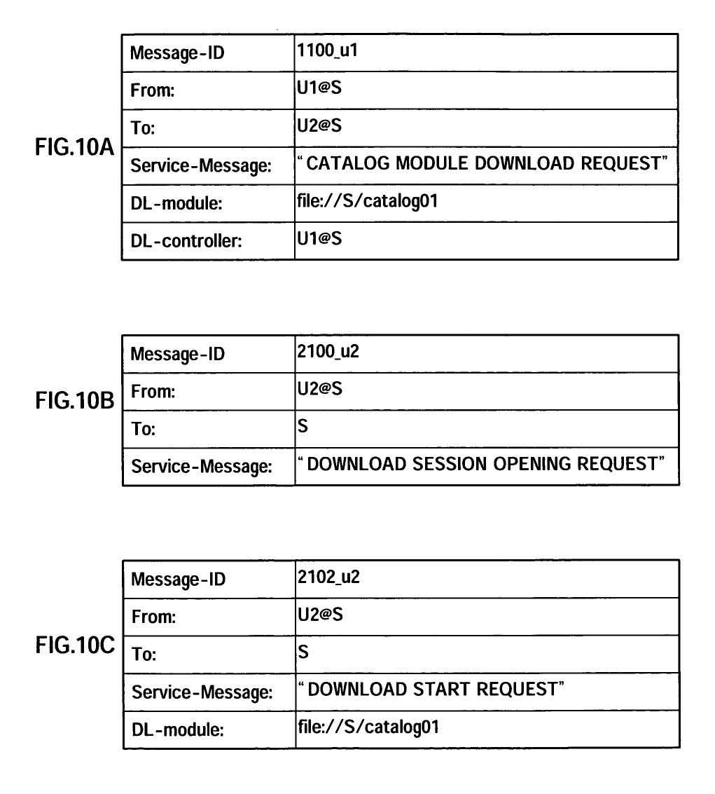

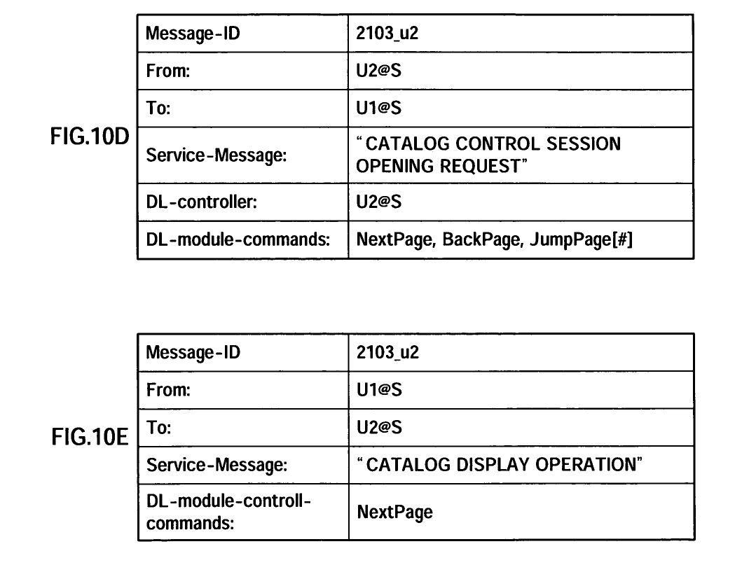

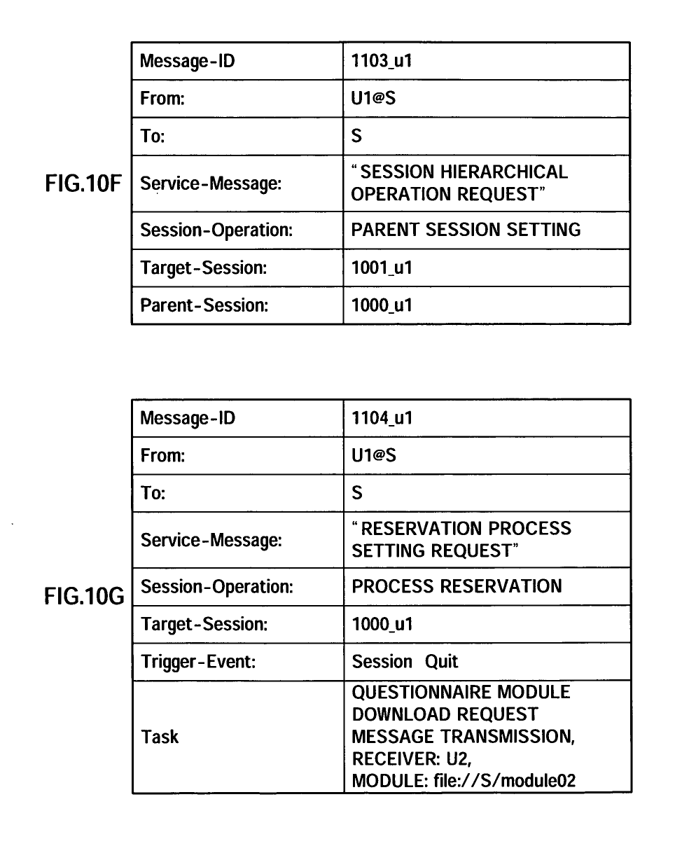

Next, messages (commands) transmitted/received between the apparatuses will be explained using FIG. 10A to FIG. 10G. FIG. 10A to FIG. 10G illustrate configuration examples of various messages transmitted/received between the call terminal 100 and server 300 and between the server 300 and call terminal 200.

Each message is constructed of a message header section indicating a message sender, a message receiver and the message name and a body section indicating contents according to the message. With regard to the descriptions of the sender/receiver of the message header section, in the case of the description of the call terminal, for example, the call terminal 100 (U1) is expressed as “U1@S” in the figure and this explicitly indicates “the terminal U1 within the domain S under the control of the server 300 (S)” and can be actually expressed in this way. In the following explanations of FIG. 10A to FIG. 10G, the call terminal 100, call terminal 200 and server 300 will be abbreviated to “terminal U1”, “terminal U2” and “server S” respectively.

<Download Request Process>

FIG. 10A illustrates an example of a message whereby the terminal U1 requests the terminal U2 to download a catalog module and is constructed by the following data:

The message header section indicates:
Message ID: “1100_u1”
Sender: “U1”
Receiver: “U2”
Message contents: “catalog module download request” and the body section indicates:
Download module storage location: “catalog01 (file) in server S”
Catalog control session opening destination: “U1”

Here, the catalog control session opening destination data indicates the receiver of the catalog control session opening request message shown in FIG. 10D and the message requests that the catalog module should be downloaded and requests the terminal U1 to open a catalog control session at the time of execution of the download module.

Especially, when a plurality of salesmen sell their products using their own call terminals by specifying the connection destination data of the control session at the time of message transmission without embedding the connection destination data in the catalog module, there is an advantage that it is possible to use the same catalog module without preparing a module that matches each salesman's call terminal.

<Download Process>

FIG. 10B shows an example of a message whereby the terminal U2 requests the server S to open a download session and the message is constructed of the following data:

The message header section indicates:
Message ID: “2100_u2”
Sender: “U2”
Receiver: “S”
Message contents: “download session opening request” Here, no body section exists.

FIG. 10C shows an example of a message whereby the terminal U2 requests the server S to start a download of a catalog and the message is constructed of the following data:

The message header section indicates:
Message ID: “2102_u2”
Sender: “U2”
Receiver: “server S”
Message contents: “download start request”
The body section indicates:
Download module storage location: “catalog01 (file) in server S”

Here, since the call terminals are generally not always of the same model or format, it is preferable to store every model of module having equivalent catalog contents in the server S and provide a download module that matches the call terminal. This can be done, for example, by specifying the name of a module set made up of modules of various types in the download module storage location data of the catalog module download request message (see FIG. 10A) instead of specifying the URL of a module file, providing a record for specifying the set name in the body section of the download session opening request message (see FIG. 10B), receiving list information made up of the module file name and its applicable model as the response thereto and specifying the module file corresponding to the model of the own terminal in the download module storage location record of the download start request message (see FIG. 10C).

A similar message format is also applicable to the questionnaire module (download process).

<Catalog Control Process>

FIG. 10D illustrates an example of a message whereby the terminal U2 requests the terminal U1 to open a catalog control session and the message is constructed of the following data:

The message header section indicates:
Message ID: “2103_u2”
Sender: “U2”
Receiver: “U1”
Message contents: “catalog control session opening request”
and the body section indicates:
Catalog control session opening destination: “U2” Type of catalog operation command: “NextPage (go to next page), BackPage (go back to previous page), JumpPage[#] (go to specified page [to page number #])”

Here, a catalog capable of page turning having sequential arrangement and display is assumed as the type of a catalog operation command and expressed as “NextPage, BackPage, JumpPage [#]”, etc., but in the case of operation of an object of a displayed product, it is also possible to express as “CloseUp Item1 (shows an enlarged view of product 1)”, etc. Furthermore, in the case of video that shows the movement of a product or contents of simulation operation, it is also possible to express “Play (reproduction)”, “Stop (stop)” or “Open Door1 (open door 1)”, “TurnOn Light1 (turn on light 1), etc.”

<Catalog Display Operation Process>

FIG. 10E illustrates an example of a catalog display operation message from the terminal U1 to the terminal U2 and the message is constructed of the following data:

The message header section indicates:
Message ID: “2103_u2”
Sender: “U1”
Receiver: “U2”
Message contents: “catalog display operation”
The body section indicates:
Catalog operation command: “NextPage”

Here, when a session to be directly communicated between the terminals U1 and U2 is opened and control information is exchanged, updating of the catalog display operation message between the terminals U1 and U2 via the server S can be done by describing communication conditions of the relevant session in the body section of a catalog control session opening request message. In that case, the message structure is not limited to the above described message structure and a message in an own format specified by the module may also be used.

<Hierarchical Operation Request>

FIG. 10F illustrates an example of a message whereby the terminal U1 requests the server S to set the parent session of the session ID=11 (1001_u1) to session ID=1 (1000_u1) and the message is constructed of the following data:

The message header section indicates:
Message ID: “1103_u1”
Sender: “U1”
Receiver: “S”
Message: “session hierarchical operation request”
The body section indicates:
Operation type: “setting of parent data”
Target session: “session 1001_u1”
Parent session: “session 1000_u1” (left blank when setting is canceled)

When the operation type is changed to change/cancel parent data or perform an inquiry process about the setting condition, this process can be executed in the relevant message format.

<Reservation Process Setting Request>

FIG. 10G illustrates an example of a message whereby the terminal U1 requests the server S to reserve transmission of a download request for downloading a questionnaire module from the server S to the terminal U2 at the closing of session ID=1 (1000_u1) and the message is constructed of the following data:

The message header section indicates:
Message ID: “1104_u1”
Sender: “U1”
Receiver: “S”
Message contents: “reservation process setting request”
The body section indicates:
Operation type: “setting of reserved data”
Target session: “session 1000_u1”
Status change event: “closing of session”
Process contents: “download of questionnaire module, server S, questionnaire #1”

Here, the process contents include information for generating messages to be transmitted to the respective devices. Furthermore, it goes without saying that even when the operation type is changed to change or cancel the setting or perform an inquiry process about the setting condition, this process can be executed in the relevant message format.

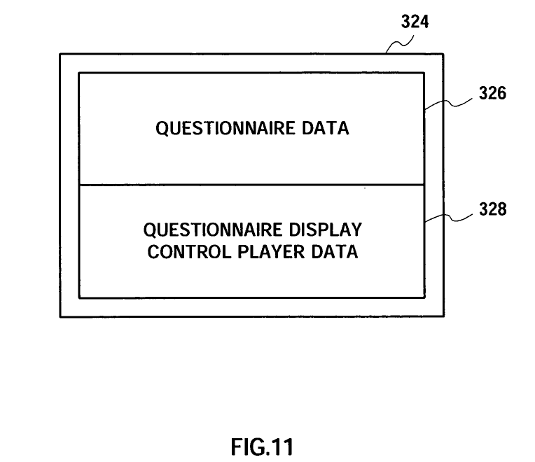

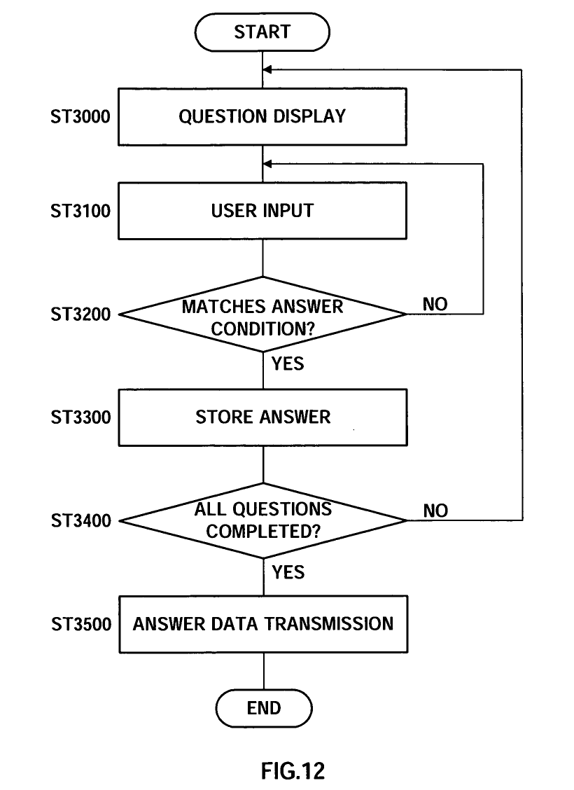

Next, the configuration of the questionnaire module and module operation process flow will be explained using FIG. 11 and FIG. 12.

FIG. 11 illustrates an example of a questionnaire module downloaded from the server 300 to the call terminal 200. The questionnaire module 324 shown in FIG. 11 is constructed of questionnaire data 326 and questionnaire display control player data 328.

The questionnaire data 326 includes, for example, question contents made up of text, image, speech, video, answering method thereof, question data made up of choices and answer reference materials, etc., question layout data made up of the question contents and arrangement and presentation order of choices, question presentation order according to the answer result, collection method data constructed of destination and transmission method of answer data, etc.

The questionnaire display control player data 328 includes, for example, program data which presents each question based on the questionnaire data 326, generates answer data while receiving user input operation and transmits the answer data to a counting server as questionnaire answer data.

When the call terminal 200 downloads such a questionnaire module 324 from the server 300, the call terminal 200 loads and starts the questionnaire display control player data 328 according to an internal operation program and reproduces/executes the questionnaire module 324.

FIG. 12 is a flow chart illustrating an example of steps of a questionnaire module reproduction process at the call terminal 200.

First, in step ST3000, the initial display screen (first question) of the questionnaire contents is displayed.

Then, in step ST3100, a user input is received.

In step ST3200, it is decided whether the user input received in step ST3100 matches the answer condition or not. When this decision result shows that the user input matches the answer condition (ST3200: YES), the process moves to step ST3300 and when the user input does not match the answer condition (ST3200: NO), the process moves back to step ST3100 and repeats the user input until the user input matches the answer condition.

In step ST3300, the user input that matches the answer condition is stored as answer data.

That is, in step ST3100 to step ST3300, the user input is received and the answer data is stored. However, it is checked whether the user input matches the answer condition or not and if the user input does not match the answer condition, the user input is repeated until the user input matches the answer condition.

In step ST3400, it is decided whether all questions are completed or not. When this decision result shows that all questions are completed (ST3400: YES), the process moves to step ST3500 and when all questions are not completed (ST3400: NO), the process moves back to step ST3000, searches and displays the next question and repeats the processes in step ST3100 to step ST3300.

In step ST3500, there is no more question to be displayed, and therefore all the stored answer data are transmitted to the destination based on the questionnaire collection method data.

The questionnaire display process contents are not particularly limited, and can be not only characters, graphics or photos but also expression formats using speech and video, etc. Furthermore, the user input may be received when the questionnaire is displayed or may be received after the display.

Furthermore, the user input apparatus and input data (answer data) format in step ST3100 are not particularly limited, and it goes without saying that the user input apparatus and input data format can be not only selection number data and character data by operation buttons of a remote controller/front panel of the call terminal or a keyboard, etc., but also graphic data by a touch panel or mouse device, etc., or speech data spoken using a microphone or camera device, hand signal or gesture video data.

Then, a specific example of the overall process sequence will be explained using sequence diagrams in FIG. 13A to FIG. 13D. In addition to the processes of distributing/displaying a catalog for the call terminal 200 according to a user operation input at the call terminal 100 and mutually displaying the catalog, FIG. 13A to FIG. 13D illustrate process sequences according to this embodiment when a questionnaire module is transmitted/displayed for the call terminal 200 according to the user operation input at the call terminal 100 and a questionnaire answer is obtained, together with the session condition. In the following explanations, the call terminal 100, call terminal 200 and server 300 will be abbreviated to “terminal U1”, “terminal U2” and “server S” respectively.

Here, more specifically, the process sequence in the entire system shown in FIG. 13A to FIG. 13D consists of six process stages; video call process (see FIG. 13A and (a) in FIG. 13B), module download process (see (b) in FIG. 13B), control session opening/display control process (see FIG. 13B and (c) in FIG. 13C), questionnaire transmission reservation process (see (d) in FIG. 13C), call session closing process (see FIG. 13C and (e) in FIG. 13D) and questionnaire module download/questionnaire answering process (see (f) in FIG. 13D). Each stage will be explained below. Suppose the server S stores a customer questionnaire module beforehand in addition to an electronic catalog module of a car.

Video Call Process (see FIG. 13A and (a) in FIG. 13B)

Step ST1: A call session opening notice is transmitted from the terminal U1 to the terminal U2 through the server S, a video call session (ID=1) is opened and video communication is started.

More specifically, the terminal U1 transmits a call session opening message to the terminal U2 through the server S. In response to this opening message, the terminal U2 transmits to the terminal U1 through the server S a call bell operation response and, when the call is accepted, an acceptance response. In response to this acceptance response, the terminal U1 transmits an ACK (Acknowledgement: positive response) to the terminal U2 through the server S. Through this series of processes, a multimedia communication session is opened between the terminal U1 and terminal U2 and bidirectional video data communication is started.

Module Download Process (see (b) in FIG. 13B)

Step ST2: A catalog module download request message is transmitted from the terminal U1 to the terminal U2 through the server S.

Step ST3: The terminal U2 transmits a download session opening request message to the server S and opens a download session (ID=2) with the server S.

Step ST4: The terminal U2 further transmits a module download request message to the server S and receives a catalog module. After receiving the catalog module, the download session (ID=2) is closed.

Control Session Opening/Display Control Process (See FIG. 13B and (c) in FIG. 13C)

Step ST5: The terminal U2 executes/displays a catalog module and transmits a catalog control session opening request message with the terminal U1 to the server S.

Step ST6: The server S transmits a message to the terminal U1 and opens a catalog control session (ID=3) for connecting the terminal U1 and terminal U2.

Step ST7: Then, the terminal U1 transmits a session hierarchical control request message for registering the catalog control session (ID=3) as a child session of the call session (ID=1) (ID=4). Furthermore, at the same time, a message (reservation setting request message) for reserving a process of closing a catalog control session when the call session is closed is also transmitted (ID=5)

Step ST8: The terminal U1 receives the user's catalog display operation input, changes the display and transmits a display operation message to the terminal U2.

Step ST9: The terminal U2 which has received the display operation message from the terminal U1 changes the catalog display according to the message contents.

Questionnaire Transmission Reservation Process (See (d) in FIG. 13C)

Step ST10: The terminal U1 receives the user's questionnaire transmission operation input and transmits/sets a reservation setting request message for reserving an operation of “transmitting a download request message of a questionnaire module to the terminal U2” to/in the server S when the call session (ID=1) is closed (ID=6).

Call Session Closing Process (See FIG. 13C and (e) in FIG. 13D)

Step ST11: The terminal U1 receives the user's call end operation input and transmits a request message for closing a call session (ID=1) to the server S.

Step ST12: The server S executes not only the call session (ID=1) closing process but also catalog control session closing process (ID=3) reserved in step ST7 and notifies the terminal U1 that the closing process has been completed (ID=6). Furthermore, the server S executes the download request message transmission process (ID=7) for the terminal U2 reserved in step ST10.

Questionnaire Module Download/Questionnaire Answering Process (see (f) in FIG. 13D)

Step ST13: The terminal U2 transmits a download session opening request message to the server S and opens a download session (ID=8) with the server S.

Step ST14: Furthermore, the terminal U2 transmits a module download request message to the server S and receives a questionnaire module. Then, after receiving the questionnaire module, the terminal U2 closes a download session (ID=8). The terminal U2 also notifies the result to the terminal U1 (ID=6).

Step ST15: The terminal U2 executes/displays the questionnaire module.

Step ST16: The terminal U2 receives the user's questionnaire answer input and answer end input, generates answer data and transmits it to the terminal U1 through the server S (ID=9).

This embodiment has described the case where a process message for setting/registering process contents when a session is closed in step ST7 (reservation setting request message) is transmitted consecutively as a message independent of the process message (session hierarchical control request message) which sets/registers the session hierarchy, but the present invention is not limited to this and it is also possible, as shown in FIG. 13A and (c) in FIG. 13B, to include the process message in the session hierarchical control request message as an operation attribute value when the session is closed and transmit the process message simultaneously and cause the server S to set the process message.

Furthermore, in step ST12, the server process has been explained as the call session closing process, catalog display control session closing process, and questionnaire module download request message transmission process in that order, but the present invention is not limited to this and it is also possible to execute the reservation process before the session closing process or execute in a changed order or simultaneously as a parallel process the process whose result remains unchanged even if the order of the operation is changed.

Furthermore, in step ST14, the result is notified in order to allow the terminal U1 to confirm that the download process from the server S to the terminal U2 has been completed, but the present invention is not limited to this and it is also possible to notify the reservation process result together with session ID and reservation contents. Furthermore, this can also be executed through reservation/registration in step ST10. This can also be easily executed by causing the terminal to inquire of the server about the result and by providing a function for the server to respond to the inquiry.

Furthermore, in step ST16, the case where questionnaire answer data is transmitted using an instant message (IM) communication protocol has been explained, but the present invention is not limited to this and it is also possible to use a communication protocol whereby a download (upload) session is opened and the questionnaire answer data is transmitted as in the case of downloading a catalog or questionnaire module. Furthermore, the questionnaire answer data may also be transmitted using a file transfer protocol (FTP), electronic mail or independent data transmission protocol.

Furthermore, it has been explained that in step ST16, the fact that the terminal U1 is the receiver of the answer is preset for the questionnaire module, but the present invention is not limited to this, and it is of course possible to set so that the answer is transmitted to the server S or an answer counting server on the Internet which is different from the server S.

Thus, this embodiment sets a hierarchical relationship among sessions, reserves/registers processes to be executed when a session connection state is changed for each session such as closing of a session, and can thereby execute useful session hierarchical control in a tele-marketing call service using a plurality of sessions and realize a tele-marketing additional call service in which a session performs an opening or closing operation according to the state of another session.

As a result, for example, when a salesman presents a customer questionnaire in a call sale with a customer using a call terminal, it is possible to realize a system that allows the salesman to inform the customer of the intention to send a questionnaire and display the questionnaire on the customer's terminal immediately after the call sale ends. Furthermore, it is possible to realize a system that can finish presentation of product catalogs and documents, etc., simultaneously with the closing of the call. Thus, it is possible to present documents not necessarily requiring the continuation of a call, automatically collect the answer, proceed with a sale to the next customer, eliminate the necessity for performing complicated operation inputs to end many sessions, making it possible to perform beneficial session hierarchical control and realize efficient sales.

This embodiment has explained the communication system (tele-marketing service system) using an SIP as an example of an applicable communication system, but the present invention is not limited to this and the present invention is applicable to a communication system using an arbitrary communication protocol other than SIP.

As described above, the present invention can perform beneficial session hierarchical control in a communication system.

This application is based on the Japanese Patent Application No. 2002-375305 filed on Dec. 25, 2002, entire content of which is expressly incorporated by reference herein.

### INDUSTRIAL APPLICABILITY

The present invention is applicable to a communication system such as a tele-marketing service system using an SIP.

What is claimed is:

1. A terminal apparatus comprising:
a session opening request section that requests the opening of a session with a specified terminal apparatus;
a reservation process setting request section that requests the setting of a reservation process executed when the opened session is changed; and
a session closing request section that requests the closing of the opened session.

2. The terminal apparatus according to claim 1, further comprising a session hierarchical operation request section that requests a change operation of a hierarchical relationship among a plurality of opened sessions.

3. The terminal apparatus according to claim 2, wherein said hierarchical relationship is specified by a session ID assigned to each session.

4. A terminal apparatus comprising:
a session opening request reception section that receives a session opening request requesting the opening of a session with a specified terminal apparatus;
a session opening section that opens a session with a specified terminal apparatus according to the received session opening request;
a session closing request reception section that receives a session closing request according to a reservation process executed when the opened session is changed; and
a session closing section that closes the opened session according to the received session closing request.

5. A session control apparatus comprising:
a session opening request reception section that receives a session opening request requesting the opening of a session with a specified terminal apparatus;
a reservation process setting request reception section that receives a reservation process setting request requesting the setting of a reservation process executed when the opened session is changed;
a session closing request reception section that receives a first session closing request requesting the closing of the opened session;
a hierarchy setting section that sets a hierarchal relationship among a plurality of opened sessions according to the received session opening request;
a hierarchy update section that updates the set hierarchal relationship according to the received first session closing request;
a reservation process setting section that sets a reservation process executed when the opened session is changed, according to the received reservation process setting request;
a reservation process execution section that executes the set reservation process according to the received first session closing request; and
a session closing request transmission section that transmits a second session closing request requesting the closing of a session with the specified terminal apparatus according to the closing of the reservation process executed.

6. The session control apparatus according to claim 5, further comprising:
a session hierarchical operation request reception section that receives a session hierarchical operation request requesting a change operation on a hierarchical relationship among a plurality of opened sessions; and
a hierarchy change section that changes a hierarchical relationship according to the received session hierarchical operation request.
